(19) United States
(12) Patent Application Publication
(10) Pub. No.: US 2005/0259860 A1
(43) Pub. Date: Nov. 24, 2005

(54) Method and device for inspecting workpieces

(76) Inventors: Frank Lewin, Wilstedt (DE); Michael Linke, Ahrensburg (DE)

Correspondence Address: Friedrich Kueffner, Suite 910, 317 Madison Avenue, New York, NY, 10017, US

(21) Appl. No.: 11/129,052

(22) Filed: May 13, 2005

(30) Foreign Application Priority Data
May 15, 2004 (DE) 10 2004 024 277.1

(51) Int. Cl. H04N 7/18

(52) U.S. Cl. 382/141; 348/127

(57) ABSTRACT

A method for inspecting workpieces includes guiding the workpieces past an inspection camera by a rotating transport wheel and analyzing the data provided by the inspection camera by an evaluation unit. A device for inspecting workpieces includes a rotatable transport wheel for the workpieces as well as an inspection camera connected to an evaluation unit. The workpieces are supported by brackets of the transport wheel which are movably arranged relative to each other such that the workpieces are moved in the area of the inspection camera with a medium speed which is lower than the medium speed of the brackets along the travel path of the brackets.

### BACKGROUND OF THE INVENTION

1. Field of the Invention

The invention relates to a method and a device for inspecting workpieces, wherein the workpieces are guided past an inspection camera by means of a rotating transport wheel, and wherein the data provided by the inspection camera is analyzed by an evaluation unit.

The invention further relates to a device for inspecting workpieces, comprising a rotatable transport wheel for the workpieces as well as an inspection camera which is connected with an evaluation unit.

2. Description of the Related Art

Such methods and devices can be deployed, for example for the inspection of preforms or bottles, in the area of a device for the blow-molded production of receptacles.

Receptacle molding by means of blow pressure action involves feeding preforms made out of thermoplastic material such as, for example preforms made of PET (polyethylene terephthalate), to various processing stations within a blow machine. Such a blow machine typically includes a heating device as well as a blowing device. Within the area of these devices the previously tempered preform is expanded to a receptacle by means of biaxial orientation. The expansion is effected with the aid of compressed air which is conducted into the preform to be expanded. The procedure of a method for such a preform expansion is described in DE-OS 43 40 291. The previously mentioned introduction of the pressurized gas also encompasses both the pressurized gas introduction into the developing receptacle bubble and the pressurized gas introduction into the preform at the beginning of the blow procedure.

The basic configuration of a blow station for molding receptacles is described in DE-OS 42 12 583. Alternatives for heating the preforms are described in DE-OS 23 52 926.

Within the device for blow-molding, the preforms as well as the blown receptacles can be transported by means of various handling equipment. The use of transport mandrels on which preforms are placed has proven especially effective. The preforms however can also be handled with other conveying devices. The use of gripping pliers for handling preforms and the use of expanding mandrels which can be inserted for mounting into the opening area of the preform also belong to available construction options.

A handling of receptacles by means of transfer wheels is described for example in DE-OS 199 06 438 with an arrangement of a transfer wheel between a blow wheel and an output section.

The already described handling of preforms results on the one hand by means of so-called two-step methods in which the preforms are first manufactured in an injection-molding process, are then stored and only later conditioned with respect to their temperature and blown up to a receptacle. On the other hand, so-called one-step methods are applied in which the preforms immediately following their injection-molded fabrication and sufficient hardening are suitably heated and subsequently blown up.

Regarding blow stations deployed, various designs are known. Often molds exhibiting book-like opening properties are found in blow stations which are arranged on rotating transport wheels. However, it is also possible to deploy molds which can be shifted relative to each other or guided in different ways. Typically plates arranged parallel to each other are used as molds in stationary blow stations which are especially suitable for accommodating several cavities for receptacle molding.

The methods deployed thus far for inspecting workpieces using an inspection camera are subject to considerable restrictions concerning the inspections performed per time unit or require very technically sophisticated inspection cameras in order to achieve a high throughput rate. Depending on the resolution as well as the processing speed of the inspection cameras as well as the efficiency of the deployed evaluation unit, it is necessary to position the workpiece to be inspected in the area of the inspection camera for a specified minimum time period or to direct the workpiece past the inspection camera with a specified maximum speed.

### SUMMARY OF THE INVENTION

It is the object of the present invention to improve the method of the afore-mentioned type such that a greater number of workpieces can be inspected per time unit without reducing the quality of inspection.

### DETAILED DESCRIPTION OF THE INVENTION

This object is met according to the present invention in that workpieces are supported by brackets of the transport wheel which are movably arranged relative to each other such that the workpieces are moved in the area of the inspection camera with a medium speed which is lower than the medium speed of the brackets along their rotation path.

It is a further object of the present invention to design a device of the afore-mentioned type which provides an inspection device that provides both high inspection quality and a high throughput rate.

The object is met according to the present invention in that the transport wheel is equipped with brackets which are movably guided relative to each other and in that the brackets are connected with a movement control which specifies a lower transport speed for the supporting members supported by the brackets for the workpieces in the area of the inspection camera than in at least an additional section of the transport path of the supporting members.

By supporting workpieces with supporting members, which in turn are positioned by brackets, it is possible to specify a varying transport speed of the workpieces along their transport path by means of a suitable movement specification for the brackets. In particular, it is possible to decelerate the workpieces prior to reaching the inspection camera and again accelerate them after passing by the inspection camera. Thus, depending on the actual movement control effected, the workpieces can be briefly paused or at least moved with considerably reduced speed.

The specification of a variable speed makes it possible to attain a very high throughput rate of workpieces while simultaneously performing a high-quality inspection of the workpieces which ensures a sorting out of faulty workpieces despite the use of comparatively inexpensive inspection cameras.

In order to lower the relative speed between the workpieces and the inspection camera in the area of recording it is proposed to decelerate the workpieces prior to the inspection camera in the transport direction.

The positioning movement of the brackets can easily be deduced from the rotational movement of the transport wheel in that the deceleration of the workpieces is effected by a swiveling movement of the brackets.

An additional option for reducing the transport speed of the workpieces involves effecting a deceleration of the workpieces by telescoping the brackets.

In addition, the deceleration of the workpieces can also be effected by a vertical swiveling of the brackets.

The subsequent transport of faulty workpieces can be prevented in that a sorting out unit is activated by the evaluation unit following the detection of a faulty workpiece.

High reproduction accuracy of the movement performance can be achieved in that the brackets are positioned by a curve controlling means.

A high resolution can be ensured for the optional recording of information in that image data of the workpieces is recorded by a CCD-camera.

A high evaluation quality is supported by the fact that image processing is carried out in the area of the evaluation unit.

The processing of optical data by means of a PC contributes to the economical performance of the method.

A further improvement of the evaluation quality can be effected in that the workpieces are lighted in the area of the inspection camera.

During the inspection of transparent workpieces it is especially advantageous to analyze the shadow formation in the area of the workpieces.

According to a preferred embodiment both the method and the device are employed for the inspection of workpieces in the area of a device for blow-molding of receptacles. According to an embodiment preforms are thereby optically checked prior to blow-molding and faulty preforms are sorted out. According to a further embodiment an optical inspection of the blow-molded receptacles takes place following their removal from the blow stations.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of the blow station for producing receptacles out of preforms;

FIG. 2 is a longitudinal cross-sectional view of a blow-mold in which a preform is stretched and expanded;

FIG. 3 is a schematic illustration of the basic design of a device for blow-molding receptacles;

FIG. 4 is a modified heating section with increased heating capacity; and

FIG. 5 is a perspective view of an inspection camera which is arranged in the area of a transport wheel equipped with brackets.

### DETAILED DESCRIPTION OF THE INVENTION

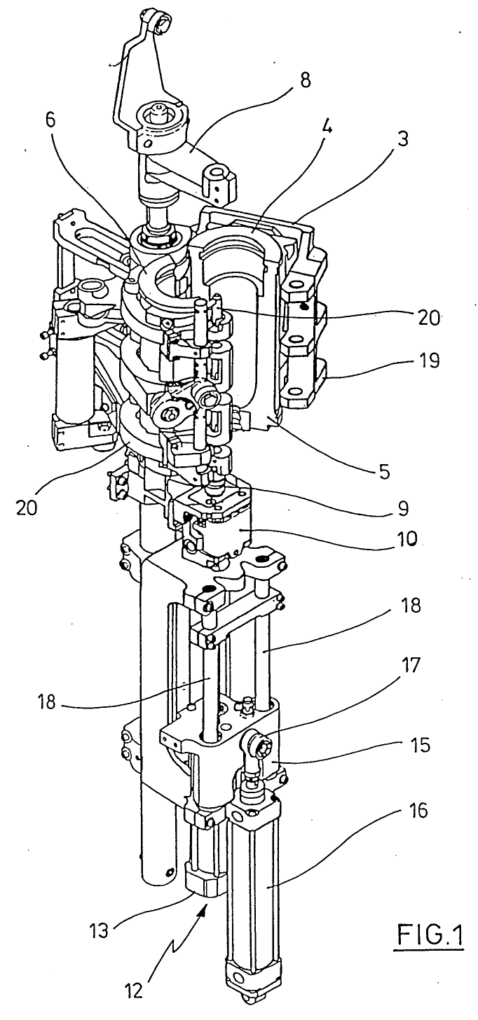

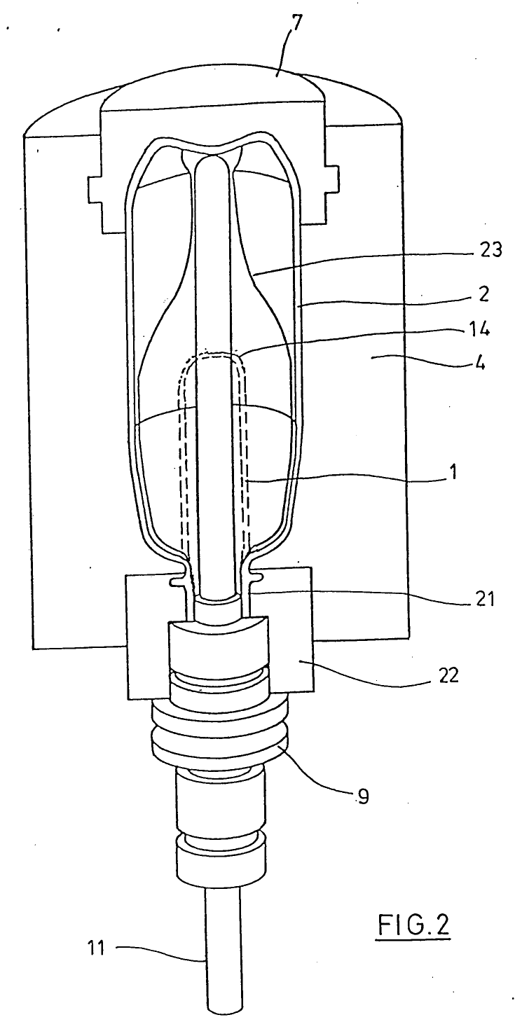

The basic design of a device for molding preforms 1 into receptacles 2 is shown in FIGS. 1 and 2.

The device for molding a receptacle 2 is composed essentially of a blow station 3 which is equipped with a blow-mold 4 into which a preform 1 can be inserted. The preform 1 can be an injected-molded piece made of polyethylene terephthalate. For enabling the insertion of the preform 1 into the blow-mold 4 and for enabling a removal of the finished receptacle 2, the blow-mold 4 comprises two mold halves 5, 6 and a base part 7 which can be positioned by means of a lifting device 8. In the area of the blow station 3 the preform 1 can be held by a transport mandrel 9 which together with the preform 1 passes through a number of treatment stations within the device. However, it is also possible to directly insert the preform 1 into the blow-mold 4, for example by means of grippers or other handling means.

For enabling the compressed air supply a connection piston 10 is arranged underneath the transport mandrel 9 which feeds compressed air to the preform 1 and simultaneously carries out sealing relative to the transport mandrel 9. However, in a modified design it is also conceivable to use fixed compressed air supply pipes.

A stretching of the preform 1 is carried out by means of a stretching rod 11 which is positioned by a cylinder 12. According to an alternative embodiment a mechanical positioning of the stretching rod 11 is carried out by means of curve segments which are mounted on callipering rollers.

In the embodiment shown in FIG. 1 the stretching system is designed such that a tandem arrangement of two cylinders 12 is provided. First the stretching rod 11 is inserted by a primary cylinder 13 into the preform 1 up into the area of the base 14 prior to the actual stretching procedure. During the actual stretching procedure the primary cylinder 13 with an extended stretching rod is positioned together with a work table 15 carrying the primary cylinder 13 by a secondary cylinder 16 or by means of a curve controlling means. In particular, it is considered to deploy the curve-controlled secondary cylinder 16 such that an active stretching position is specified by a guide roll 17 which glides along a curved path during the stretching procedure. The guide roll 17 is pushed against the guideway by the secondary cylinder 16. The work table 15 glides along two guide elements 18.

After closing the mold halves 5, 6 arranged in the area of the supports 19, 20, a locking of the supports 19, 20 relative to each other is effected by means of a locking device 20.

In order to adapt to various shapes of the opening area 21 of the preform 1 the use of separate threaded inserts 22 is provided for in the area of the blow-mold 4 according to FIG. 2.

FIG. 2 shows in addition to the blown up receptacle 2 the preform 1 drawn with dashed lines and a developing receptacle bubble 23 shown schematically.

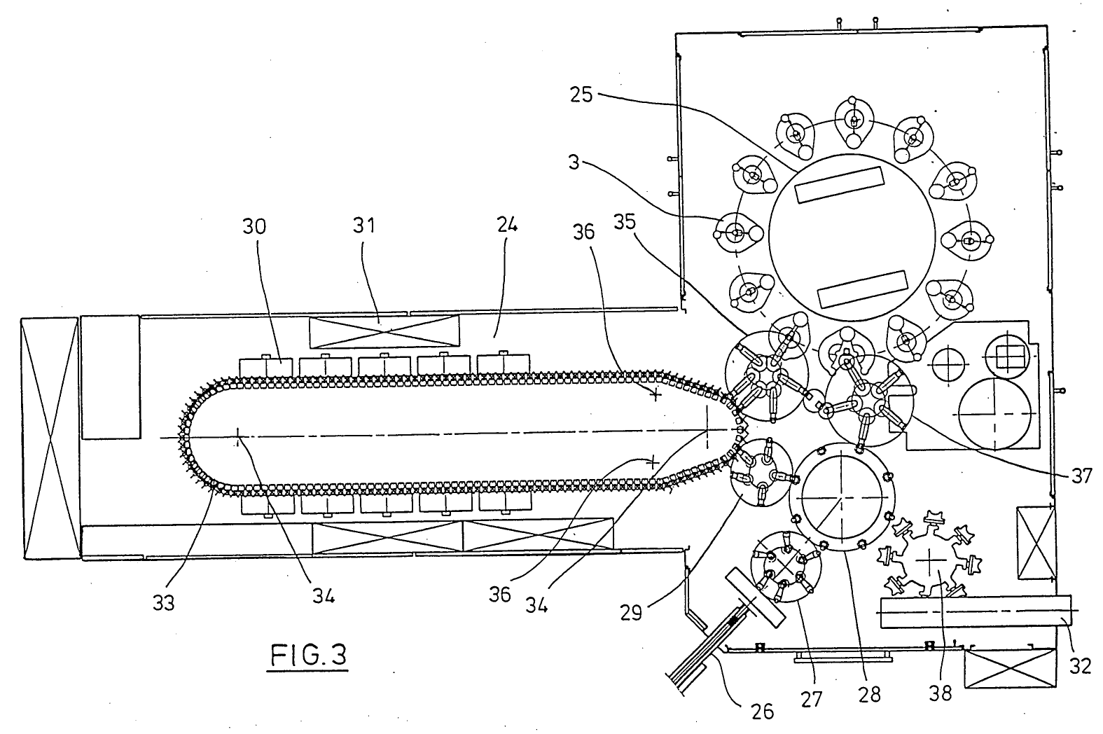

FIG. 3 shows the basic design of a blow machine which is equipped with a heating section 24 and a rotating blow wheel 25. Starting with the preform input 26 the preforms 1 are transported by means of transfer wheels 27, 28, 29 into the area of the heating section 24. Radiant heaters 30 and ventilators 31 are arranged along the heating section 24 for tempering the preforms 1. Following adequate tempering of the preforms 1 they are transferred to the blow wheel 25 in the area where the blow stations 3 are arranged. The finished blown up receptacles 2 are led by additional transfer wheels to an output section 32.

In order to be able to mold a preform 1 into a receptacle 2 such that the receptacle 2 exhibits certain material characteristics that ensure a long utilization capacity of food products bottled in the receptacle 2, particularly of beverages, special procedural steps must be adhered to during the heating and orientation of the preforms 1. In addition, advantageous effects can be achieved by adhering to certain dimensioning instructions.

Various plastics can be used as thermoplastic material. For example PET, PEN or PP can be deployed.

The expansion of the preform 1 during the orientation procedure is effected by means of compressed air supply. The compressed air supply is divided into a pre-blow phase in which gas, for example compressed air is fed in with a low pressure level, and a subsequent main blow phase in which gas is fed in with a higher pressure level. During the pre-blow phase compressed air is typically used with an interval of 10 bars to 25 bars. During the main blow phase compressed air is fed in with a pressure in the interval of 25 bars to 40 bars.

FIG. 3 also shows that in the illustrated embodiment, the heating section 24 is comprised of a multitude of circulating transport elements 33 which are arranged like a chain next to each other and are guided along deflection wheels 34. In particular, it is considered to mount an essentially rectangular base contour by means of the chain-like arrangement. In the shown embodiment a single, relatively large dimensioned deflection wheel 34 is used in the area of the extension of the heating section 24 facing the transfer wheel 29 and an input wheel 35, and two comparatively smaller dimensioned deflection wheels 36 are used in the area of adjacent deflections. In principle, however, other arbitrary guides are conceivable.

The shown arrangement has proven especially practical for enabling the closest possible arrangement of the transfer wheel 29 and the input wheel 35 relative to each other, since three deflection wheels 34, 36 are positioned in the area proportionate to the extension of the heating section 24. Namely the smaller deflection wheels 36 are positioned in the area of the transition to the linear extensions of the heating section 24 and the larger deflection wheel is positioned in the immediate transfer area to the transfer wheel 29 and to the input wheel 35. As an alternative to using chain-line transport elements 35, it is possible to use a rotating heating wheel.

Following the complete blowing of the receptacles 2 they are led out of the area of the blow stations 3 by the removal wheel 37 and transported to the output section 32 via a transfer wheel 28 and an output wheel 38.

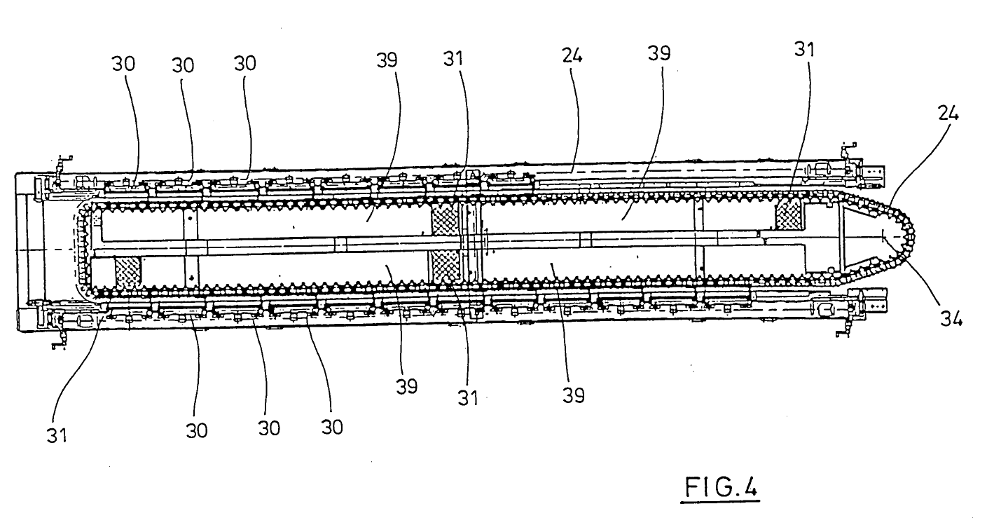

A larger number of preforms 1 can be tempered per unit of time by a greater number of radiant heaters 30 in the modified heating section 24 shown in FIG. 4. The ventilators 31 feed cooling air into the area of the cooling air ducts 39 which are each located opposite the assigned radiant heaters 30 and dispense cooling air via discharge outlets. By aligning the discharge directions it is possible to effect a flow direction for the cooling air which is essentially diagonal to a transport direction of the preforms 1. The cooling air ducts 39 can provide reflectors for radiant heating in the area of the surfaces opposite the radiant heaters 30. However, it is also possible to effect a cooling of the radiant heaters 30 by means of the dispensed cooling air.

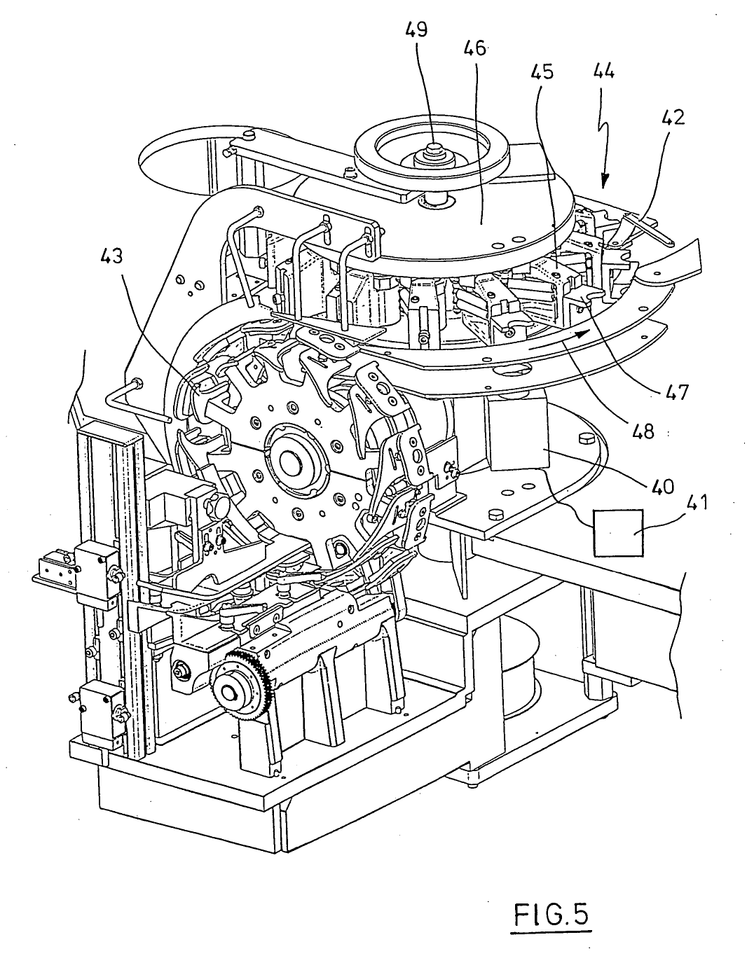

FIG. 5 shows an inspection camera 40 in the area of a device for blow-molding receptacles 3. The inspection camera 40 is connected to an evaluation unit which controls a sorting out unit 42 for sorting out workpieces, not shown, which are identified as faulty. The workpieces shaped as preforms 1 are typically fed to the device for blow-molding along the preform input 26 shown in FIG. 3 with the opening area 21 pointing up in vertical direction and then turned by a turning wheel 43 and transferred to a transport wheel 44 which is designed as a transfer wheel 27 according to the embodiment in FIG. 3.

The transport wheel 44 is equipped with brackets 45 which are movably arranged relative to the base element 46 of the transport wheel 4. Due to the movable arrangement of the brackets the brackets 45 can also change their positioning relative to each other.

In the illustrated embodiment the brackets 45 are equipped with supporting members 47 for the workpieces. The workpieces can be transported by the supporting members 47 directly or with the help of separate coupling members.

In the illustrated embodiment according to FIG. 5 the brackets 45 are pivotably arranged relative to the transport wheel 44 in a circumferential direction 48 of the transport wheel 44. The swiveling axes of the brackets 45 extend hereby essentially parallel to a rotational axis 49 of the transport wheel 44.

A curve controlling means is preferably used for conducting the respective positioning movements of the brackets 45 relative to the transport wheel 45. The brackets are equipped for this purpose with guide rollers which are guided along a curved path. By means of the movement drive of the brackets 45 the supporting members 47 and consequently the workpieces are decelerated in the circumferential direction 48 prior to reaching the inspection camera 45 and accelerated again after passing the inspection camera 45. For this purpose, the supporting members are spaced apart in circumferential direction 48 such that an appropriate space is provided for deceleration and acceleration paths to be carried out.

As an alternative to the pivotability of the brackets 45 shown in FIG. 5 it is also conceivable to effect a decrease of the peripheral speed of the workpieces by telescoping or raising of the brackets 45. According to an alternative embodiment it is also possible to specify a low relative speed between the workpieces and the inspection camera 40, so that the inspection camera 40 is arranged on a circulating rotating support whose rotation path overlaps the rotation path of the transport wheel 44, such that an essentially identical transport speed and transport direction of the workpieces and the inspection camera 40 is achieved in the area of recording.

While specific embodiments of the invention have been shown and described in detail to illustrate the inventive principles, it will be understood that the invention may be embodied otherwise without departing from such principles.

1. A method for inspecting workpieces, the method comprising
guiding the workpieces past an inspection camera by means of a rotating transport wheel,
analyzing data provided by the inspection camera by means of an evaluation unit,
supporting the workpieces by means of brackets of the transport wheel, wherein the brackets are moveably arranged relative to each other such that the workpieces are moved in an area of the inspection camera with a medium speed which is lower than a medium speed of the brackets along a travel path of the brackets.

2. The method according to claim 1, comprising decelerating the workpieces in the travel path prior to reaching the inspection camera.

3. The method according to claim 2, comprising effecting deceleration of the workpieces by carrying out a horizontal pivoting movement of the brackets.

4. The method according to claim 2, comprising effecting deceleration of the workpieces by carrying out a telescoping of the brackets.

5. The method according to claim 2, comprising effecting deceleration of the workpieces by carrying out a vertical swivelling of the brackets.

6. The method according to claim 1, comprising activating a sorting out unit following an identification of faulty workpieces by the evaluation unit.

7. The method according to claim 1, comprising positioning the brackets by a curve control means.

8. The method according to claim 1, comprising recording image data of the workpieces by a CCD-camera.

9. The method according to claim 1, comprising carrying out an image processing in an area of the evaluation unit.

10. The method according to claim 1, comprising processing optical information by means of a PC.

11. The method according to claim 1, comprising lighting the workpieces in the area of the inspection camera.

12. The method according to claim 1, comprising evaluating shadow formations in the area of the workpieces.

13. A device for inspecting workpieces, the device comprising
a rotatable transport wheel for the workpieces,
an inspection camera connected to an evaluation unit,
brackets mounted on the transport wheel, wherein the brackets are movably guided relative to each other,
a movement control means connected to the brackets for effecting a transport speed of the supporting members of the workpieces supported by the brackets in an area of the inspection camera that is lower than the transport speed in at least an additional section of a transport path of the supporting members.

14. The device according to claim 13, wherein the movement control means comprises means for decelerating and for accelerating the brackets.

15. The device according to claim 13, wherein the movement control means is configured for horizontal pivoting of the brackets.

16. The device according to claim 13, wherein the movement control means is configured to carry out a telescoping movement of the brackets.

17. The device according to claim 13, wherein the movement control means is configured for vertically swivelling the brackets.

18. The device according to claim 13, comprising a sorting out unit connected to the evaluation unit for sorting out faulty workpieces.

19. The device according to claim 13, wherein the movement control means is configured as a curve controlling means.

20. The device according to claim 13, wherein the inspection camera is a CCD-camera.

21. The device according to claim 13, wherein the evaluation unit comprises an image processing device.

22. The device according to claim 13, wherein the evaluation unit is at least partly implemented on a PC.

23. The device according to claim 13, further comprising a lighting device for lighting the workpieces in an area of the inspection camera.

24. The device according to claim 13, wherein the evaluation unit is configured to evaluate shadow formation in an area of the workpieces.

25. The device according to claim 13, further comprising a device for blow-molding receptacles including at least one blow station, wherein the inspection camera and the transport wheel are arranged in an area of the device for blow-molding receptacles.
